(19) United States
(12) Patent Application Publication
(10) Pub. No.: US 2005/0131140 A1
(43) Pub. Date: Jun. 16, 2005

(54) Modified silicone adhesives and sealants

(76) Inventor: Yuduo Zhu, Grand Prairie, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 10/737,711

(22) Filed: Dec. 16, 2003

(51) Int. Cl. C08L 83/04

(52) U.S. Cl. 524/863

(57) ABSTRACT

The present invention provides improved compositions and methods for producing moisture-cured adhesives and sealants based on modified silicone polymers. Methods of the present invention do not require a discrete step to dry the fillers that are incorporated into the materials and produce products with an excellent shelf life.

### BACKGROUND OF THE INVENTION

Modified silicone (“MS”) polymers are materials that have polypropyleneoxide as the backbone of the main chain and contain dimethoxysilyl groups that cap at end of the chains. These polymers can be formulated with various plasticizers, fillers, and other additives to produce products with specific properties to meet application requirements. The products based on MS polymers make up a wide range of high quality adhesives and sealants that may be cured under ambient conditions.

One of the most desirable features of MS-based adhesives and sealants is a long shelf life. This is accomplished by producing an adhesive/sealant that has very low moisture content. Typically, the desired moisture level for such a moisture-cured adhesive/sealant should be below 0.05% or 500 ppm.

The adhesives/sealants industry has traditionally used two primary methods to “dry” moisture-cured adhesives and sealants. The first is to dry all of the fillers, such as CaCO₃ and TiO₂, in an oven, other heating device, after first grinding them to a fine powder to increase the exposed surface area. This process is generally performed under a vacuum. The other method typically used is to remove the water azeotropically by adding a solvent such as toluene to a vessel containing the fillers and removing the solvent by distillation. Both ways are very costly and time-consuming.

Therefore, there remains a need to make adhesive and sealants that are less costly and time consuming. The present invention provides an improved method for the production of MS-containing adhesives and sealants that addresses the needs mentioned above as well as other objectives that will be appreciated by those skilled in the art.

### SUMMARY OF THE INVENTION

The present invention solves problems associated with the efficient production of MS polymer-based sealants and adhesives. The present invention provides methods for producing moisture-cured adhesives and sealants based on MS polymers and compositions thereof. Methods of the present invention do not require a discrete step to dry fillers that are incorporated into the materials. The present invention produces products that have a good shelf life. Additionally, the adhesives and sealants that are produced with the present invention can be free of volatile organic compounds, i.e. VOC free.

Generally and in one form, the present invention provides a curable composition comprising a moisture curable material and a volatile component in an effective amount sufficient to prevent the curable composition from curing (e.g., undergoing a drying process). The weight percent of the volatile component is generally between 2% and 15%. The volatile component is one of many generally known to those of ordinary skill in the art, such as an organic solvent, an ester of a carboxylic acid, an organic acetate, a methyl ester, as examples. The curable material may further compromise a modified silicone polymer. Notably, the curable composition does not require a water-scavenging agent.

The present invention also provides a method of preparing a curable composition comprising the step of combining a moisture curable material with a volatile component in an effective amount sufficient to prevent the curable composition from curing. As such, the curable material may, in one aspect, further compromise a modified silicone polymer.

In yet another form, the present invention provides a curable composition comprising a moisture curable material and methyl acetate in an effective amount sufficient to prevent the curable composition from curing. The weight percent of methyl acetate is generally between 2% and 15%. When the weight percent of methyl acetate is below 2%, the non-drying process generally does not work. In addition, when the weight percent of methyl acetate is greater than 15%, the moisture-curing process is delayed at ambient temperatures. Again, the curable composition does not require a water-scavenging agent. In addition, the curable material may further compromise a modified silicone polymer.

In yet another embodiment, the present invention provides a curable composition comprising a moisture curable material and a volatile component, wherein the volatile component is in an effective amount sufficient to prevent a water-scavenging agent from being required.

Those skilled in the art will further appreciate the above-mentioned advantages and features of the present invention, together with other important aspects thereof upon reading the detailed description that follows in conjunction with the data provided in the tables.

### DETAILED DESCRIPTION OF THE INVENTION

Although the making and using of various embodiments of the present invention are discussed in detail below, it should be appreciated that the present invention provides a number of inventive concepts that may be embodied in a wide variety of contexts. The specific aspects of the invention discussed herein are merely illustrative of ways to make and use the present invention, and are not meant to limit its scope is any manner.

Examples of Compositions and Methods of the Present Invention

A general procedure is used for the preparation of compounds of the present invention in which the drying process is eliminated and a water-scavenging agent is not required. This is generally because of the addition of a volatile agent that eliminates the need for a drying process. It will be appreciated by those skilled in the art, after reading this application, that the described procedure is not the only means for achieving the results presented herein; modifications available to one of ordinary skill in the art are made to the procedure that achieve similar results. Such modifications are considered to be part of the present invention.

TABLE 1 shows the process of not drying adhesives and sealants. Three samples were made in Table 1. Sample #1 was made based on a traditional process, meaning drying fillers in a mixer. An initial step for Sample #1 is the grinding of the starting materials to achieve consistence and to aid the drying process that forms one of the steps of the present invention. Typically, the polymers, fillers, pigments, UV absorbers, and thixotropic agents that are to form the basis of a composition are combined and ground to a fine paste.

TABLE I
Examples of a Non-drying Process

| | Sample #1 | | Sample #2 | | Sample #3 | |
|---|---|---|---|---|---|---|
| Chemical | Mass (g) | Wt % | Mass (g) | Wt % | Mass (g) | Wt % |
| MS Polymer S203H | 487.00 | 11.41 | 440.00 | 9.82 | 487.00 | 11.32 |
| MS Polymer S303H | 627.00 | 14.69 | 600.00 | 13.39 | 627.00 | 14.58 |
| Winnofil SPM (CaCO3) | 1412.00 | 33.08 | 1430.00 | 31.92 | 1430.00 | 33.25 |
| Duramite (CaCO3) | 535.00 | 12.54 | 450.00 | 10.04 | 550.00 | 12.79 |
| Ti-Pure R902 (TiO2) | 127.00 | 2.98 | 125.00 | 2.79 | 127.00 | 2.95 |
| Aristowax 143 (Wax) | 38.00 | 0.89 | 38.00 | 0.85 | 38.00 | 0.88 |
| DIDP | 837.00 | 19.61 | 700.00 | 15.63 | 837.00 | 19.46 |
| Toluene | 100.00 | 2.34 | 100.00 | 2.23 | | |
| Methyl Acetate | | | 500.00 | 11.16 | 100.00 | 2.33 |
| Disperbyk 161 | 4.00 | 0.09 | 4.00 | 0.09 | 4.00 | 0.09 |
| Expancel | 19.00 | 0.45 | 18.00 | 0.40 | 19.00 | 0.44 |
| Silquest A-171 (VTMO) | 22.00 | 0.52 | 20.00 | 0.45 | 22.00 | 0.51 |
| Silquest A-1120 | 45.00 | 1.05 | 40.00 | 0.89 | 45.00 | 1.05 |
| Fomrez SUL-11A | 15.00 | 0.35 | 15.00 | 0.33 | 15.00 | 0.35 |
| TOTAL | 4268.00 | 100.00 | 4480.00 | 100.00 | 4301.00 | 100.00 |

After combining the basic composition, the ground ingredients are then combined with a plasticizer and solvent, and dried. Toluene is an example of a solvent that may be used, although others may be used to azeotropically remove any water present in any of the ingredients. Before measuring the water content, the mixer is cooled down below 120 degrees Fahrenheit. With this method, it is possible to achieve moisture content as low as 0.01-0.05%, preferably 0.01-0.03%. By drying in this manner, a water-scavenging agent is not required.

When all of the ingredients have been sufficiently combined, reduced pressure may once again be applied. This helps to remove any entrapped air that may be present in the finished formulation. The material may be placed in a tube, pail, or drum for eventual use in the various applications.

Sample #2 and #3 are produced in a different way. Like Sample #1, Sample #2 and #3 are ground thoroughly. Instead of drying immediately after grinding, some methyl acetate is added into the formula when the mixer is below 80 degrees Fahrenheit. Following this, a dehydration agent, an adhesion promoter, a density reduction material, and a catalyst can be added into the mixer. No nitrogen protection is necessary.

A stability study was conducted. Three samples stored at 120 degrees Fahrenheit for 4 weeks, were all still in a paste form without noticeable change in viscosity. As such, the concept of non-drying works. In addition, methyl acetate can block any possible curing before application. Once the non-drying adhesives and sealants are exposed to atmospheric condition, and methyl acetate is evaporated, the adhesives and sealants cured as fast as those adhesives and sealants made with drying process.

More systematic study has been conducted and results indicate that the non-drying process works well to serve the stability requirement for adhesives and sealants. Better yet, the resultant products are VOC-free. TABLE 2 shows some non-drying formulas without Expancel, a density reduction material, while TABLE 3 shows some formulas with the addition of Expancel. TABLE 4 depicts results of separate sample formulas using methods of the present invention.

While specific alternatives to steps of the invention have been described herein, additional alternatives not specifically disclosed but known in the art are intended to fall within the scope of the invention. Thus, it is understood that other applications of the present invention will be apparent to those skilled in the art upon reading the described embodiment and after consideration of the appended claims and drawing.

TABLE 2
Non-drying Process without Expancel

| | Sample #4 | | Sample #5 | | Sample #6 | |
|---|---|---|---|---|---|---|
| Chemical | Mass (g) | Wt % | Mass (g) | Wt % | Mass (g) | Wt % |
| MS Polymer S203H | 500.00 | 11.55 | 500.00 | 9.12 | 380.00 | 8.79 |
| MS Polymer S303H | 644.00 | 14.88 | 644.00 | 11.75 | 488.00 | 11.28 |
| Winnofil SPM | 880.00 | 20.33 | 1800.00 | 32.85 | 1360.00 | 31.45 |
| (CaCO3) | | | | | | |
| Duramite (CaCO3) | 1300.00 | 30.03 | 550.00 | 10.04 | 420.00 | 9.71 |
| Ti-Pure R902 | 100.00 | 2.31 | 100.00 | 1.82 | 75.00 | 1.73 |
| (TiO2) | | | | | | |
| Aristowax 143 | 39.00 | 0.90 | 39.00 | 0.71 | 39.00 | 0.90 |
| (Wax) | | | | | | |
| diisodecyl phthatlate | 689.00 | 15.92 | 860.00 | 15.69 | 650.00 | 15.03 |
| Toluene | 100.00 | 2.31 | 100.00 | 1.82 | 75.00 | 1.73 |
| Methyl Acetate | | | 800.00 | 14.60 | 758.00 | 17.53 |
| Silquest A-171 | 22.00 | 0.51 | 22.00 | 0.40 | 20.00 | 0.46 |
| (VTMO) | | | | | | |
| Silquest A-1120 | 40.00 | 0.92 | 50.00 | 0.91 | 45.00 | 1.04 |
| Fomrez SUL-11A | 15.00 | 0.35 | 15.00 | 0.27 | 15.00 | 0.35 |
| TOTAL | 4329.00 | 100.00 | 5480.00 | 100.0 | 4325.00 | 100.0 |

| | | | |
|---|---|---|---|
| P/B ratio | 1.99 | 2.14 | 2.14 |
| Solid, % | 98.21 | 84.64 | 86.96 |
| Brookfield, #5 | 176,000 | 81,920 | 86,680 |
| @5 rpm | | | |
| Gravity, #/gallon | 12.36 | 11.32 | 11.15 |
| Channel Sag, inch | 0.3 | <2.0 | <2.0 |
| 2-week Solid, % | 98.01 | 84.21 | 86.30 |
| 2-week Brookfield, | 181,100 | 84,480 | 87,500 |
| #5@5 rpm | | | |
| 2-week Gravity, | 12.28 | 11.39 | 11.14 |
| #/gallon | | | |
| 2-week Channel | 0.3 | <2.0 | <2.0 |
| Sag, inch | | | |
| 2-week Shore A, | 29 | 34 | 33 |
| Condition | | | |
| 2-week Shore A, | 29 | 34 | 33 |
| QUV | | | |
| 4-week Solid, % | 98.15 | 84.13 | 86.07 |
| 4-week Brookfield, | 182,800 | 84,880 | 88,600 |
| #5@5 rpm | | | |
| 4-week Gravity, | 12.31 | 11.37 | 11.17 |
| #/gallon | | | |
| 4-week Channel | 0.3 | <2.0 | <2.0 |
| Sag, inch | | | |
| 4-week Shore A, | 29 | 34 | 33 |
| Condition | | | |
| 4-week Shore A, | 29 | 34 | 33 |
| QUV | | | |
| Tensile, psi | 356.2 | 432.5 | 455.7 |
| Elongation, % | 689 | 678 | 598 |
| Peel-Glass, pli | 28.9 CF | 30.2 CF | 30.3 CF |
| Peel-Aluminum, pli | 29.1 CF | 29.8 CF | 30.2 CF |
| Peel-Concrete, pli | 20.1 AF/CF | 18.7 AF/CF | 21.6 AF/CF |

| | Sample #7 | | Sample #8 | |
|---|---|---|---|---|
| Chemical | Mass (g) | Wt % | Mass (g) | Wt % |
| MS Polymer S203H | 380.00 | 9.44 | 380.00 | 9.10 |
| MS Polymer S303H | 488.00 | 12.12 | 488.00 | 11.69 |
| Winnofil SPM (CaCO3) | 600.00 | 14.91 | 400.00 | 9.58 |
| Duramite (CaCO3) | 880.00 | 21.86 | 980.00 | 23.47 |
| Ti-Pure R902 (TiO2) | 75.00 | 1.86 | 75.00 | 1.80 |
| Aristowax 143 (Wax) | 39.00 | 0.97 | 39.00 | 0.93 |
| diisodecyl phthatlate | 650.00 | 16.15 | 900.00 | 21.56 |
| Toluene | 75.00 | 1.86 | 75.00 | 1.80 |
| Methyl Acetate | 758.00 | 18.83 | 758.00 | 18.16 |
| Silquest A-171 (VTMO) | 20.00 | 0.50 | 20.00 | 0.48 |
| Silquest A-1120 | 45.00 | 1.12 | 45.00 | 1.08 |
| Fomrez SUL-11A | 15.00 | 0.37 | 15.00 | 0.36 |
| TOTAL | 4025.00 | 100.00 | 4175.00 | 100.00 |

| | | |
|---|---|---|
| P/B ratio | 1.79 | 1.68 |
| Solid, % | 87.10 | 83.00 |
| Brookfield, #5 @5 rpm | 65,820 | 7,680 |
| Gravity, #/gallon | 11.27 | 10.50 |
| Channel Sag, inch | <2.0 | <2.0 |
| 2-week Solid, % | 86.25 | 82.19 |
| 2-week Brookfield, #5@5 rpm | 67,800 | 8,000 |
| 2-week Gravity, #/gallon | 11.25 | 10.51 |
| 2-week Channel Sag, inch | <2.0 | <2.0 |
| 2-week Shore A, Condition | 27 | 26 |
| 2-week Shore A, QUV | 27 | 26 |
| 4-week Solid, % | 85.85 | 82.19 |
| 4-week Brookfield, #5@5 rpm | 68,200 | 7,900 |
| 4-week Gravity, #/gallon | 11.26 | 10.5 |
| 4-week Channel Sag, inch | <2.0 | <2.0 |
| 4-week Shore A, Condition | 27 | 26 |
| 4-week Shore A, QUV | 27 | 26 |
| Tensile, psi | 389.4 | 367.8 |
| Elongation, % | 723 | 755 |
| Peel-Glass, pli | 29.8 CF | 31.2 CF |
| Peel-Aluminum, pli | 29.4 CF | 30.9 CF |
| Peel-Concrete, pli | 17.9 AF/CF | 16.9 AF/CF |

TABLE 3
Non-drying Process with Expancel

| | | |
|---|---|---|
| Sample #9 | Sample #10 | Sample #11 |

| Chemical | Mass (g) | Wt % | Mass (g) | Wt % | Mass (g) | Wt % |
|---|---|---|---|---|---|---|
| MS Polymer S203H | 487.00 | 11.41 | 440.00 | 10.74 | 440.00 | 10.91 |
| MS Polymer S303H | 627.00 | 14.69 | 600.00 | 14.64 | 600.00 | 14.88 |
| Winnofil SPM (CaCO3) | 1412.00 | 33.08 | 1430.00 | 34.90 | 1430.00 | 35.46 |
| Duramite (CaCO3) | 535.00 | 12.54 | 450.00 | 10.98 | 450.00 | 11.16 |
| Ti-Pure R902 (TiO2) | 127.00 | 2.98 | 125.00 | 3.05 | 125.00 | 3.10 |
| Aristowax 143 (Wax) | 38.00 | 0.89 | 38.00 | 0.93 | 38.00 | 0.94 |
| DIDP | 837.00 | 19.61 | 700.00 | 17.09 | 700.00 | 17.36 |
| Toluene | 100.00 | 2.34 | | | | |
| Water | | | | | | |
| Methyl Acetate | | | 205.00 | 5.00 | 141.00 | 3.50 |
| Disperbyk 161 | 4.00 | 0.09 | 4.00 | 0.10 | 4.00 | 0.10 |
| Expancel | 19.00 | 0.45 | 20.00 | 0.49 | 20.00 | 0.50 |
| Silquest A-171 (VTMO) | 22.00 | 0.52 | 20.00 | 0.49 | 20.00 | 0.50 |
| Silquest A-1120 | 45.00 | 1.05 | 50.00 | 1.22 | 50.00 | 1.24 |
| Fomrez SUL-11A | 15.00 | 0.35 | 15.00 | 0.37 | 15.00 | 0.37 |
| TOTAL | 4268.00 | 100.00 | 4097.00 | 100.00 | 4033.00 | 100.00 |

| | | |
|---|---|---|
| Moisture, % | 0.1317 | 0.2187 |
| Moisture, % | 0.1355 | 0.2265 |
| Solid, % | 95.02 | 95.19 |
| Viscosity, Sec/20 | 8.56 | 8.14 |
| G/40 psi | | |
| Viscosity, Brookfield, | 264,300 | 264,300 |
| 5/5/77F | | |
| Gravity, #/Gallon | 10.58 | 10.31 |
| Channel Sag, inch | 0 | 0.1 |
| 2-week Solid, % | 93.2 | Cured |
| 2-week Viscosity, sec/20 | 13.18 | In |
| G/40 psi | | |
| 2-week Viscosity, | 380,000 | Tube |
| Brookfield, 5/5/77F | | |
| 2-week Gravity, #/gallon | 10.51 | |
| 2-week Channel Sag, | 0 | |
| inch | | |
| 2-week Shore A, | 32 | 33 |
| condition | | |
| 2-week Shore A, QUV | 32 | 33 |
| 4-week Solid, % | 94.6 | |
| 4-week Viscosity, sec/20 | 12.41 | Cured |
| G/40 psi | | |
| 4-week Viscosity, | 360,000 | In |
| Brookfield, 5/5/77F | | |
| 4-week Gravity, #/gallon | 10.51 | Tube |
| 4-week Channel Sag, | 0 | |
| inch | | |
| 4-week Shore A, | 32 | 31 |
| condition | | |
| 4-week Shore A, QUV | 32 | 32 |
| Tensile, psi | 201.1 | 178.9 |
| Elongation, % | 345 | 374 |
| 100% Modulus, psi | 113.5 | 83.4 |
| 50% Modulus, psi | 72.8 | 46.6 |
| 25% Modulus, psi | 36.8 | 25.6 |
| Peel-Glass, pli | 15 CF | 10 CF |
| Peel-Aluminum, pli | 15 CF | 10 CF |
| Peel-Concrete, pli | 7 AF | 5 AF |

| | Sample #12 | | Sample #13 | | Sample #14 | | Sample #15 | |
|---|---|---|---|---|---|---|---|---|
| Chemical | Mass (g) | Wt % | Mass (g) | Wt % | Mass (g) | Wt % | Mass (g) | Wt % |
| MS Polymer S203H | 440.00 | 10.74 | 440.00 | 10.73 | 440.00 | 10.50 | 440.00 | 10.51 |
| MS Polymer S303H | 600.00 | 14.64 | 600.00 | 14.63 | 600.00 | 14.32 | 600.00 | 14.33 |
| Winnofil SPM | 1430.00 | 34.90 | 1430.00 | 34.87 | 1430.00 | 34.12 | 1430.00 | 34.15 |
| (CaCO3) | | | | | | | | |
| Duramite (CaCO3) | 450.00 | 10.98 | 450.00 | 10.97 | 450.00 | 10.74 | 450.00 | 10.75 |
| Ti-Pure R902 (TiO2) | 125.00 | 3.05 | 125.00 | 3.05 | 125.00 | 2.98 | 125.00 | 2.99 |
| Aristowax 143 (Wax) | 38.00 | 0.93 | 38.00 | 0.93 | 38.00 | 0.91 | 38.00 | 0.91 |
| DIDP | 700.00 | 17.09 | 700.00 | 17.07 | 700.00 | 16.70 | 700.00 | 16.72 |
| Toluene | | | | | | | | |
| Water | | | 4.00 | 0.10 | 4.00 | 0.10 | | |
| Methyl Acetate | 205.00 | 5.00 | 205.00 | 5.00 | 295.00 | 7.04 | 295.00 | 7.05 |
| Disperbyk 161 | 4.00 | 0.10 | 4.00 | 0.10 | 4.00 | 0.10 | 4.00 | 0.10 |
| Expancel | 20.00 | 0.49 | 20.00 | 0.49 | 20.00 | 0.48 | 20.00 | 0.48 |
| Silquest A-171 | 20.00 | 0.49 | 20.00 | 0.49 | 20.00 | 0.48 | 20.00 | 0.48 |
| (VTMO) | | | | | | | | |
| Silquest A-1120 | 50.00 | 1.22 | 50.00 | 1.22 | 50.00 | 1.19 | 50.00 | 1.19 |
| Fomrez SUL-11A | 15.00 | 0.37 | 15.00 | 0.37 | 15.00 | 0.36 | 15.00 | 0.36 |
| TOTAL | 4097.00 | 100.00 | 4101.00 | 100.00 | 4191.00 | 100.00 | 4187.00 | 100.00 |

| | | | | |
|---|---|---|---|---|
| Moisture, % | 0.08418 | 0.2269 | 0.2761 | 0.1121 |
| Moisture, % | 0.07411 | 0.2472 | 0.2923 | 0.1326 |
| Solid, % | 95.67 | 97.82 | 95.7 | 96.57 |
| Viscosity, sec/20 | 8.67 | 22.84 | 14.39 | 16.04 |
| G/40 psi | | | | |
| Viscosity, Brookfield, | | 188,800 | 256,000 | 325,100 |
| 5/5/77F | | | | |
| Gravity, #/gallon | 10.53 | 10.51 | 10.35 | 10.37 |
| Channel Sag, inch | 0.1 | 0.05 | >0.3 | 0 |
| 2-week Solid, % | 95.43 | 98.02 | Cured | 95.67 |
| 2-week Viscosity, | 27.98 | 128.52 | In | 20.91 |
| sec/20 G/40 psi | | | | |
| 2-week Viscosity, | 289,900 | 239,000 | Tube | 313,200 |
| Brookfield, 5/5/77F | | | | |
| 2-week Gravity, | 10.52 | 10.49 | | 10.34 |
| #/gallon | | | | |
| 2-week Channel Sag, | 0.1 | 0 | | 0 |
| inch | | | | |
| 2-week Shore A, | 32 | 33 | | 30 |
| condition | | | | |
| 2-week Shore A, | 32 | 33 | | 30 |
| QUV | | | | |
| 4-week Solid, % | 95.23 | 87.34 | | 95.52 |
| 4-week Viscosity, | 24.73 | 223.1 | Cured | 31.1 |
| sec/20 G/40 psi | | | | |
| 4-week Viscosity, | 295000 | 320,000 | In | 357,700 |
| Brookfield, 5/5/77F | | | | |
| 4-week Gravity, | 10.53 | 10.54 | Tube | 10.44 |
| #/gallon | | | | |
| 4-week Channel Sag, | 0 | 0 | | 0 |
| inch | | | | |
| 4-week Shore A, | 31 | 32 | 32 | 30 |
| Condition | | | | |
| 4-week Shore A, | 30 | 31 | 32 | 30 |
| QUV | | | | |
| Tensile, psi | 181.5 | 185.9 | 176.5 | 179.2 |
| Elongation, % | 380 | 383 | 390 | 361 |
| 100% Modulus, psi | 75.2 | 78.5 | 68.5 | 47.4 |
| 50% Modulus, psi | 50.1 | 47.3 | 48.9 | 24.2 |
| 25% Modulus, psi | 27.5 | 24.6 | 26.3 | 12.2 |
| Peel-Glass, pli | 10 CF | 10 CF | 10 CF | 10 CF |
| Peel-Aluminum, pli | 10 CF | 10 CF | 10 CF | 10 CF |
| Peel-Concrete, pli | 5.5 AF | 5 AF | 6 AF | 4 AF |

TABLE 4
Additional Sample Batches with a Non-drying Process

| | Sample #16 | | Sample #17 | | Sample #18 | |
|---|---|---|---|---|---|---|
| Chemical | Mass (g) | Wt % | Mass (g) | Wt % | Mass (g) | Wt % |
| MS Polymer S203H | 370 | 10.67 | 370 | 10.55 | 370 | 10.55 |
| MS Polymer S303H | 476 | 13.72 | 476 | 13.57 | 476 | 13.57 |
| Neolight (CaCO3) | 1100 | 31.71 | 1100 | 31.37 | 1100 | 31.37 |
| Duramite (CaCO3) | 400 | 11.53 | 400 | 11.41 | 400 | 11.41 |
| Ti-Pure R902 (TiO2) | 96 | 2.77 | 96 | 2.74 | 96 | 2.74 |
| Aristowax 143 (Wax) | 28 | 0.81 | 28 | 0.80 | 28 | 0.80 |
| Jayflex DIDP | 635 | 18.30 | 635 | 18.11 | 635 | 18.11 |
| Disparlon 6500 | | | | | | |
| CaO | 32 | 0.92 | 70 | 2.00 | 70 | 2.00 |
| Methyl Acetate | 240 | 6.92 | 240 | 6.84 | 240 | 6.84 |
| Disperbyk 161 | 3 | 0.09 | 3 | 0.09 | 3 | 0.09 |
| Expancel | 16 | 0.46 | 16 | 0.46 | 16 | 0.46 |
| Silquest A-171 (VTMO) | 17 | 0.49 | 17 | 0.48 | 17 | 0.48 |
| Silquest A-1120 | 44 | 1.27 | 44 | 1.25 | 44 | 1.25 |
| Fomrez SUL-11A | 12 | 0.35 | 12 | 0.34 | 12 | 0.34 |
| TOTAL | 3469 | 100.00 | 3507 | 100.00 | 3507 | 100.00 |
| Moisture, % | 0.1743 | | 0.2003 | | 0.1643 | |
| Before CaO | 0.1809 | | 0.2043 | | 0.1770 | |
| Moisture, % | 0.1759 | | 0.1586 | | 0.1555 | |
| After CaO | 0.1875 | | 0.1720 | | 0.1440 | |
| Solid, % | 96.46 | | 97.02 | | 96.39 | |
| Viscosity, Sec/20 G/40 psi | 11.82 | | 8.46 | | 9.53 | |
| Viscosity, Sec/20 G/60 psi | | | | | | |
| Viscosity, Brookfield, | 358,400 | | 320,600 | | 348,800 | |
| 5/5/77F | | | | | | |
| Viscosity, Brookfield, | | | | | | |
| 7/100/77F | | | | | | |
| Gravity, #/Gallon | 10.20 | | 10.22 | | 10.20 | |
| Channel Sag, inch | 0.00 | | 0.00 | | 0.00 | |
| 2-week Solid, % | 97.03 | | 96.78 | | 96.45 | |
| 2-week Viscosity, sec/20 | 29.31 | | 22.63 | | 24.52 | |
| G/40 psi | | | | | | |
| 2-week Viscosity, sec/20 | | | | | | |
| G/60 psi | | | | | | |
| 2-week Viscosity, | 555,500 | | 503,400 | | 551,000 | |
| Brookfield, 5/5/77F | | | | | | |
| 2-week Viscosity, | | | | | | |
| Brookfield, 7/100/77F | | | | | | |
| 2-week Gravity, #/gallon | 10.21 | | 10.20 | | 10.21 | |
| 2-week Channel Sag, inch | 0.00 | | 0.00 | | 0.00 | |
| 2-week Shore A, Condition | 32 | | 32 | | 33 | |
| 2-week Shore A, QUV | 33 | | 33 | | 32 | |
| 4-week Solid, % | 97.41 | | 97.02 | | 96.65 | |
| 4-week Viscosity, sec/20 | 36.56 | | 24.81 | | 43.15 | |
| G/40 psi | | | | | | |
| 4-week Viscosity, sec/20 | | | | | | |
| G/60 psi | | | | | | |
| 4-week Viscosity, | 98,800 | | 96,000 | | 145,000 | |
| Brookfield, 7/100/77F | | | | | | |
| 4-week Gravity, #/gallon | 10.22 | | 10.23 | | 10.2 | |
| 4-week Channel Sag, inch | 0 | | 0 | | 0 | |
| 4-week Shore A, condition | 33 | | 33 | | 33 | |
| 4-week Shore A, QUV | 32 | | 33 | | 33 | |
| Tensile, psi | 160.7 | | 161.1 | | 158.3 | |
| Elongation, % | 360 | | 380 | | 374 | |
| 100% Modulus, psi | 76.4 | | 78.4 | | 72 | |
| 50% Modulus, psi | 49.1 | | 48.8 | | 46.5 | |
| 25% Modulus, psi | 28.8 | | 29.3 | | 29.2 | |
| Peel-Glass, pli | 10.2 CF | | 10 CF | | 10 CF | |
| Peel-Aluminum, pli | 10.6 CF | | 10 CF | | 10 CF | |
| Peel-Concrete, pli | 7 AF | | 7 AF | | 8 AF/CF | |
| | Sample #19 | | Sample #20 | | Sample #21 | |
| Chemical | Mass (g) | Wt % | Mass (g) | Wt % | Mass (g) | Wt % |
| MS Polymer S203H | 370 | 11.57 | 335 | 10.08 | 335 | 9.87 |
| MS Polymer S303H | 476 | 14.88 | 428 | 12.88 | 428 | 12.61 |
| Neolight (CaCO3) | 1100 | 34.39 | 1430 | 43.02 | 1430 | 42.13 |
| Duramite (CaCO3) | 200 | 6.25 | | | | |
| Ti-Pure R902 (TiO2) | 96 | 3.00 | 200 | 6.02 | 300 | 8.84 |
| Aristowax 143 (Wax) | 28 | 0.88 | 25 | 0.75 | 25 | 0.74 |
| Jayflex DIDP | 550 | 17.19 | 500 | 15.04 | 450 | 13.26 |
| Disparlon 6500 | | | 45 | 1.35 | 45 | 1.33 |
| CaO | 64 | 2.00 | 60 | 1.81 | 60 | 1.77 |
| Methyl Acetate | 230 | 7.19 | 220 | 6.62 | 240 | 7.07 |
| Disperbyk 161 | 3 | 0.09 | 2 | 0.06 | 2 | 0.06 |
| Expancel | 15 | 0.47 | 14 | 0.42 | 14 | 0.41 |
| Silquest A-171 (VTMO) | 15 | 0.47 | 14 | 0.42 | 14 | 0.41 |
| Silquest A-1120 | 40 | 1.25 | 40 | 1.20 | 40 | 1.18 |
| Fomrez SUL-11A | 12 | 0.38 | 11 | 0.33 | 11 | 0.32 |
| TOTAL | 3199 | 100.00 | 3324 | 100.00 | 3394 | 100.00 |

| | | | |
|---|---|---|---|
| Moisture, % | 0.1950 | 0.2067 | 0.1703 |
| Before CaO | 0.2049 | 0.1922 | 0.1712 |
| Moisture, % | 0.1798 | 0.1653 | 0.1554 |
| After CaO | 0.1881 | 0.1573 | 0.1636 |
| Solid, % | 97 | 93.12 | 92.45 |
| Viscosity, Sec/20 G/40 psi | 10.37 | | |
| Viscosity, Sec/20 G/60 psi | | 10.23 | 6.17 |
| Viscosity, Brookfield, | 402,800 | | |
| 5/5/77F | | | |
| Viscosity, Brookfield, | | 130000 | 110000 |
| 7/100/77F | | | |
| Gravity, #/gallon | 10.11 | 10.7 | 10.8 |
| Channel Sag, inch | 0.00 | 0 | 0 |
| 2-week Solid, % | 96.87 | 95.48 | 94.53 |
| 2-week Viscosity, sec/20 | 28.3 | | |
| G/40 psi | | | |
| 2-week Viscosity, sec/20 | | 27.49 | 11.64 |
| G/60 psi | | | |
| 2-week Viscosity, | 610,000 | | |
| Brookfield, 5/5/77F | | | |
| 2-week Viscosity, | | 185,600 | 148,100 |
| Brookfield, 7/100/77F | | | |
| 2-week Gravity, #/gallon | 10.12 | 10.75 | 10.85 |
| 2-week Channel Sag, inch | 0.00 | 0.00 | 0.00 |
| 2-week Shore A, condition | 32 | 37 | 36 |
| 2-week Shore A, QUV | 33 | 36 | 36 |
| 4-week Solid, % | 97.04 | 95.57 | 93.44 |
| 4-week Viscosity, sec/20 | 30.84 | | |
| G/40 psi | | | |
| 4-week Viscosity, sec/20 | | 37.74 | 12.67 |
| G/60 psi | | | |
| 4-week Viscosity, | 103,300 | 220,100 | 155,500 |
| Brookfield, 7/100/77F | | | |
| 4-week Gravity, #/gallon | 10.14 | 10.58 | 10.95 |
| 4-week Channel Sag, inch | 0 | 0 | 0 |
| 4-week Shore A, condition | 32 | 36 | 37 |
| 4-week Shore A, QUV | 32 | 37 | 36 |
| Tensile, psi | 173.6 | 167.9 | 165.5 |
| Elongation, % | 392 | 342 | 359 |
| 100% Modulus, psi | 82.6 | 86.9 | 84.5 |
| 50% Modulus, psi | 52.1 | 53.2 | 56 |
| 25% Modulus, psi | 31.2 | 33.2 | 37.5 |
| Peel-Glass, pli | 10.5 CF | 12.2 CF | 13.8 CF |
| Peel-Aluminum, pli | 10.5 CF | 11.7 CF | 14.2 CF |
| Peel-Concrete, pli | 8.5 AF/CF | 7.2 AF | 6. AF |

1. A curable composition comprising;
a moisture curable material; and
a volatile component in an effective amount sufficient to prevent the curable composition from undergoing a drying process.

2. The curable composition of claim 1, wherein the curable material further compromises a modified silicone polymer.

3. The curable composition of claim 1, wherein the volatile component is selected from the group consisting at least of an organic solvent, an ester of a carboxylic acid, an organic acetate, a methyl ester, and combinations thereof.

4. The curable composition of claim 1, wherein the weight percent of the volatile component is not below 2%.

5. The curable composition of claim 1, wherein the curable composition does not require a water-scavenging agent.

6. A method of preparing a curable composition comprising the step of:
combining a moisture curable material with a volatile component, wherein the volatile component is in an effective amount sufficient to prevent the curable composition from undergoing a drying process.

7. The method of claim 6, wherein the curable material further compromises a modified silicone polymer.

8. The method of claim 6, wherein the volatile component is selected from the group consisting at least of an organic solvent, an ester of a carboxylic acid, an organic acetate, a methyl ester, and combinations thereof.

9. The method of claim 8, wherein weight percent of the volatile component is not below 2%.

10. A curable composition comprising;
a moisture curable material; and
a methyl acetate in an effective amount sufficient to prevent the curable composition from undergoing a drying process.

11. The curable composition of claim 10, wherein the weight percent of methyl acetate is not below 2%.

12. The curable composition of claim 10, wherein the curable composition is free of volatile organic compounds.

13. The curable composition of claim 10, wherein the curable composition does not require a water-scavenging agent.

14. The curable composition of claim 10, wherein weight percentages of methyl acetate above 15% delay curing at ambient temperatures.

15. The curable composition of claim 10, wherein the curable material further compromises a modified silicone polymer.

16. A curable composition comprising;
a moisture curable material; and
a volatile component, wherein the volatile component is in an effective amount sufficient to prevent a water-scavenging agent from being required.

17. The curable composition of claim 16, wherein the curable material further compromises a modified silicone polymer.

18. The curable composition of claim 16, wherein the volatile component is selected from the group consisting at least of an organic solvent, an ester of a carboxylic acid, an organic acetate, a methyl ester, and combinations thereof.

19. A method of preparing a curable composition comprising the step of:
combining a moisture curable material with a volatile component, wherein the volatile component is in an effective amount sufficient to prevents a water-scavenging agent from being required.

20. The method of claim 19, wherein the curable material further compromises a modified silicone polymer.

21. The method of claim 19, wherein the volatile component is selected from the group consisting at least of an organic solvent, an ester of a carboxylic acid, an organic acetate, a methyl ester, and combinations thereof.
